(19) United States
(12) Patent Application Publication
(10) Pub. No.: US 2025/0246906 A1
(43) Pub. Date: Jul. 31, 2025

(54) PV Power Forecasting System

(71) Applicant: Michael Gostein, Austin, TX (US)

(72) Inventor: Michael Gostein, Austin, TX (US)

(21) Appl. No.: 19/041,970

(22) Filed: Jan. 30, 2025

Related U.S. Application Data
(60) Provisional application No. 63/627,093, filed on Jan. 31, 2024.

(51) Int. Cl. H02J 3/00; H02J 3/38

(52) U.S. Cl. CPC H02J 3/004; H02J 3/381; H02J 2203/20; H02J 2300/24

(57) ABSTRACT

In one respect, disclosed is a system for forecasting output power of a PV power plant, comprising inputs for PV power measurements by in-situ IV measurement units, and a forecast model, wherein said forecast model forecasts future PV power generation based at least upon said PV power measurements by said in-situ IV measurement units. In another respect, disclosed is a system for forecasting output power of a PV power plant, comprising inputs for PV power measurements by in-situ IV measurement units, and a forecast model, wherein said forecast model forecasts future PV power generation, and wherein said forecast model is trained based at least upon said PV power measurements by said in-situ IV measurement units.

### FIELD OF THE INVENTION

The disclosed subject matter is directed to forecasting the power output of PV power plants.

### STATEMENT OF GOVERNMENT INTEREST

Not applicable.

### CROSS-REFERENCE TO RELATED APPLICATIONS

This application claims priority to U.S. provisional patent application 63/627,093 filed Jan. 31, 2024.

### SUMMARY

In one respect, disclosed is a system for forecasting output power of a PV power plant, comprising inputs for PV power measurements by in-situ IV measurement units, and a forecast model, wherein said forecast model forecasts future PV power generation based at least upon said PV power measurements by said in-situ IV measurement units. In another respect, said forecast model forecasts power seconds, minutes, hours, or days in the future. In another respect, said system may comprise inputs for sky images from sky cameras within said PV power plant wherein said forecast model forecasts future PV power generation based at least upon said PV power measurements and said sky images. In another respect, said system may comprise inputs for satellite images or forecasted satellite images of cloud cover at said PV power plant wherein said forecast model forecasts future PV power generation based at least upon said PV power measurements and said satellite images or forecasted satellite images. In another respect, said system may comprise inputs or intermediate results for forecasted irradiance wherein said forecast model forecasts future PV power generation based at least upon said PV power measurements and said forecasted irradiance. In another respect, said system may be trained based at least upon said PV power measurements by said in-situ IV measurement units. In another respect, disclosed is a system for forecasting output power of a PV power plant, comprising inputs for PV power measurements by in-situ IV measurement units, and a forecast model, wherein said forecast model forecasts future PV power generation, and wherein said forecast model is trained based at least upon said PV power measurements by said in-situ IV measurement units.

### BRIEF DESCRIPTION OF THE DRAWINGS

FIG. 1 depicts a block diagram of an embodiment of the disclosed subject matter.

### DETAILED DESCRIPTION OF THE INVENTION

A photovoltaic (PV) power plant (100) uses solar panels, also known as PV modules, to generate electrical power. PV modules typically generate direct current (DC) electrical power. A PV power plant (100) may use inverters to convert the DC power of PV modules to alternating current (AC) power. Electrical power generated by a PV power plant (100) may be stored, used by a local electrical load, or supplied via inverters to an electrical grid.

PV modules have a characteristic current-voltage (IV) relationship, or IV curve. At a specific point on the IV curve, power output, the product of current and voltage, is maximized. PV modules are typically operated near the maximum power point (MPP). Inverters or other power conversion equipment perform maximum power point tracking (MPPT) to maintain operation of PV modules near MPP.

The power output of a PV power plant (100) is limited by the available power output of its PV modules, which depends on solar irradiance, temperature, and other factors, and may change rapidly due to the motion of clouds or changes in weather conditions.

The power output of a PV power plant (100) may also be limited by the available capacity of inverters to convert DC power output by PV modules to AC power that can be transmitted to an electrical grid. “Clipping” occurs when the output capacity of inverters is less than the available DC power from PV modules. When clipping occurs inverters operate PV modules off the MPP.

The power output of a PV power plant (100) may also be limited by the capacity of an electrical grid to receive the power, according to controls set by the operator of the grid. “Curtailment” occurs when the grid does not receive the maximum available power that can be output by inverters. When curtailment occurs, inverters operate PV modules off the MPP.

In some cases, a PV power plant (100) may be intentionally operated under curtailment to maintain reserve power so that the plant's power output can later be increased when needed by the electrical grid. Maintaining reserve power allows using the PV power plant (100) to fulfill ancillary services such as frequency or voltage support on the grid when needed.

An automatic generation control (AGC) system is a system that automatically adjusts output of a power plant according to the needs of the electrical grid. AGC systems may be used to provide ancillary services. AGC systems typically operate on a short time scale of 1-20 seconds.

The potential high limit (PHL) of a PV power plant (100) is the maximum power it can output at a given point in time as limited only by available power from PV modules and the maximum capacity of inverters, without regard to curtailment. PHL is highly variable because of its dependence on weather conditions, including solar irradiance and temperature.

Forecasting PHL at a future time point could be beneficial to integration of a PV power plant (100) with an electric grid. On the short time scale of seconds, tens of seconds, or minutes, forecasting the PHL may assist with integration within an AGC system, because knowledge of PHL is required for an AGC system to request power from a PV power plant (100) with confidence that the requested power will be reliably delivered. For time scales of minutes, hours, and days, forecasting the PHL may assist grid operators plans with planning for dispatching electricity to an electric grid from different generation sources in a given region to meet forecasted demand. Accurate forecasts of PHL improve and economize operation of the grid. Desirably, uncertainties in PHL forecasting should be reduced.

In the present disclosure, forecasting the available PV power is used interchangeably with forecasting the PHL.

The disclosed subject matter describes a system for forecasting PV power using in-situ IV measurement units for measurement, sensing, and/or training data.

In-situ IV measurement units (200) use IV measurements on PV modules to measure their IV curve and thereby determine maximum potential power output, and other electrical properties, without disconnecting the modules from a PV array. Exemplary embodiments of in-situ IV measurement units (200) are described in U.S. Pat. No. 11,843,349 and U.S. patent application Ser. No. 18/130,558, each of which is hereby incorporated by reference.

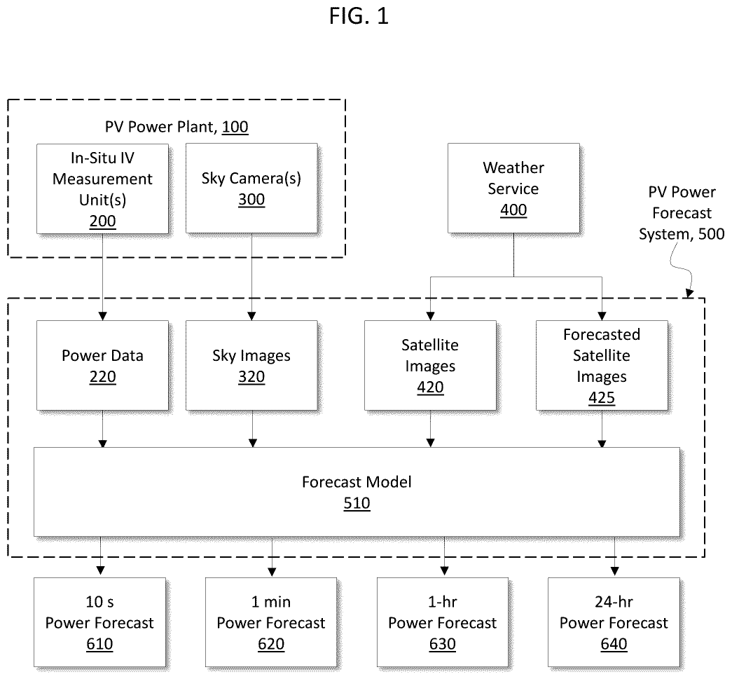

FIG. 1 depicts an embodiment of the disclosed subject matter, including a PV power forecast system (500) for forecasting the power output of a PV power plant (100). The figure depicts multiple elements which may be used in different embodiments. Not every element is used in every embodiment.

In one embodiment, one or more in-situ IV measurement units (200) are distributed throughout a PV power plant (100). At regular or irregular time intervals, these units measure IV curves, or portions of IV curves, of their connected PV module(s), from which maximum power output of the module(s) is determined. For example, measurements are performed every second, every 10 seconds, and/or every minute. In between these measurements, connected PV modules may participate normally in power production like all other modules in the PV array.

Power data (220) collected from in-situ IV measurement units (200) are provided to a PV power forecast system (500), which includes a forecast model (510). Power data (220) are input to forecast model (510) which forecasts maximum potential PV power output (PHL) of PV power plant (100) at a later point in time.

In one embodiment, in-situ IV measurement units (200) are distributed throughout a PV power plant (100), for example with typically at least one in-situ IV measurement unit (200) per inverter block, and forecast model (510) produces, for example, a 10 s power forecast (610) for the entire PV power plant (100), based at least upon the distributed in-situ IV measurement units (200). The 10 s power forecast (610) may also use information about the maximum capacity of inverters and other data. In one embodiment, forecast model (510) produces 10 s power forecast (610) by scaling the power data (220) from each in-situ IV measurement unit (200) by the number of modules in its associated inverter block to estimate the PHL of the inverter block, while considering the maximum capacity of the inverter. This scaling may be calibrated by calibration factors. In one embodiment, power data (220) include data at multiple time points, for example 10 seconds apart, and forecast model (510) analyzes data from multiple recent time points to improve 10 s power forecast (610), for example by using recent rates of change to predict a future value.

In one embodiment, PV power forecast system (500) also includes inputs for sky images (320) collected from one or more sky cameras (300) distributed throughout PV power plant (100) and aimed up at the sky. Sky images (320) may be analyzed by forecast model (510) to assist in forecasting PV power at a later point in time, for example producing a one-minute power forecast (620) or forecasting on other time scales on the order of minutes. In one embodiment this is done based at least upon analyzing sky images (320) to recognize clouds and subsequently estimate irradiance received throughout PV power plant (100) as modified by cloud shadows. In another embodiment this is done based at least upon projecting sky images (320) onto PV power plant (100) and empirically associating sky images (320) with power data (220) and/or other data on power output of the entire PV power plant (100). In some embodiments sky images (320) may include images captured at multiple time points, based at least upon which cloud motions are determined. In some embodiments cloud motions are estimated from wind speed and direction and/or other data. Determination of cloud motions is used by forecast model (510) to produce a PV power forecast at later time point, such as the exemplary one-minute power forecast (620).

In some embodiments PV power forecast system (500) includes inputs for satellite images (420) and/or forecasted satellite images (425) obtained from a weather service (400), wherein a forecasted satellite image (425) is an image produced at a given point in time which forecasts the image expected at a later point in time. In some embodiments forecast model (510) uses satellite images (420) and/or forecasted satellite images (425) to forecast PV power at a later time point, for example to produce a one-hour power forecast (630) or a 24-hour power forecast (640). In one embodiment this is done based at least upon estimating irradiance within PV power plant (100) from satellite images (420) and/or forecasted satellite images (425). In another embodiment this is done based at least upon projecting satellite images (420) and/or (425) onto PV power plant (100) and empirically associating images (420) and/or (425) with power data (220) and/or other data on power output of the entire PV power plant (100).

In some embodiments, forecast model (510) produces forecasts at one or more time scales, for example a 10 s power forecast (610), a one-minute power forecast (620), a one-hour power forecast (630), and/or a 24-hour power forecast (640). Specific time scales and intervals in this disclosure are exemplary and may be replaced by other time scales and intervals that are substantially equivalent; for example, 10 seconds may be replaced by 5 seconds, or 1 minute may be replaced by 10 minutes, etc., and in different embodiments different forecast time scales may be used. In some embodiments forecasts are produced for arbitrary or variable time scales.

PV power forecast values (e.g. 610, 620, 630, 640) are provided to a user of PV power forecast system (500), such as a human user or an automated system, including an automated system for controlling the operation of PV power plant (100) and its interconnection with an electrical grid.

PV power forecast system (500) may be located on the site of PV power plant (100) or at a remote location.

In some embodiments power data (220), sky images (320), satellite images (420) and/or forecasted satellite images (425) recorded at multiple time points are stored within PV power forecast system (500).

In some embodiments power data (220), sky images (320), satellite images (420) and/or forecasted satellite images (425) are used in combination to produce forecasts (e.g. 610, 620, 630, 640). In some embodiments power data (220) are relatively more important for near-immediate forecasting (also known as “now-casting”) such as the 10 s power forecast (610), sky images (320) are relatively more important for minutes-ahead forecasting such as the 1-minute power forecast (620), and satellite images (420) and forecasted satellite images (425) are relatively more important for longer-term forecasting such as the 1-hour power forecast (630) and/or 24-hour power forecast (640).

In some embodiments forecast model (510) is implemented as a machine-learning model. In some embodiments forecast model (510) is trained to use power data (220), sky images (320), satellite images (420), and/or forecasted satellite images (425) to produce forecasts (e.g. 610, 620, 630, 640).

In some embodiments forecast model (510) is trained based at least upon associating power data (220), sky images (320), satellite images (420), and/or forecasted satellite images (425) recorded at a given point in time with power data (220) subsequently recorded at a later point in time. In some embodiments training of forecast model (510) is performed by iteratively adjusting parameters of forecast model (510) to optimize the agreement between power forecasts (e.g. 610, 620, 630, 640) produced using data recorded at a given time point and power data (220) for the later time point corresponding to the forecast time scale or interval.

Additional information may also be used in training and/or forecasting, including, for example, solar position, weather data, calendar data, inverter data, PV module cleanliness data (“soiling”), and system operational status data.

Advantageously, training forecast model (510) to optimize the agreement between power forecasts (e.g. 610, 620, 630, 640) and power data (220) from in-situ IV measurement units (200) permits training to forecast PHL regardless of whether PV power plant (100) is curtailed.

In some embodiments, forecast model (510) is trained during an initial training period. In some embodiments, forecast model (510) is re-trained at regular or irregular intervals, for example at night, using recently collected and/or stored data.

In some embodiments, forecast model (510) is trained to associate spatial data, such as a spatial distribution of power data (220), sky images (320), satellite images (420), and/or forecasted satellite images (425) recorded at or close in time to a given time point with power data (220) and/or spatial distribution of power data (220) from a later time point.

In some embodiments, forecast model (510) contains inputs for forecasted solar irradiance (not depicted in FIG. 1), wherein said forecasted solar irradiance may comprise global, direct, diffuse, plane-of-array, ground-reflected, or rear plane-of-array irradiance components. In some embodiments, forecast model (510) itself determines forecasted solar irradiance as an intermediate result based on meteorological data. In some embodiments said forecasted solar irradiance is determined, either outside of and as an input to forecast model (510) or within forecast model (510) as an intermediate results, from ground-based and/or satellite-based meteorological data or weather service data (400). In some embodiments, said forecasted solar irradiance is used by forecast model (510) in combination with power data (220) to determine power forecasts (e.g. 610, 620, 630, 640) at a later point in time.

In some embodiments forecast model (510) is trained based at least upon associating power data (220), sky images (320), satellite images (420), and/or forecasted satellite images (425) and/or forecasted irradiance recorded at a given point in time with power data (220) subsequently recorded at a later point in time. In some embodiments training of forecast model (510) is performed by iteratively adjusting parameters of forecast model (510) to optimize the agreement between power forecasts (e.g. 610, 620, 630, 640) produced using data recorded at a given time point and power data (220) for the later time point corresponding to the forecast time scale or interval.

1. A system for forecasting output power of a PV power plant, comprising:
inputs for PV power measurements by in-situ IV measurement units, and a forecast model,
wherein said forecast model forecasts future PV power generation based at least upon said PV power measurements by said in-situ IV measurement units.

2. The system of claim 1, wherein said forecast model forecasts power seconds, minutes, hours, or days in the future.

3. The system of claim 1, further comprising inputs for sky images from sky cameras within said PV power plant and wherein said forecast model forecasts future PV power generation based at least upon said PV power measurements and said sky images.

4. The system of claim 1, further comprising inputs for satellite images or forecasted satellite images of cloud cover at said PV power plant and wherein said forecast model forecasts future PV power generation based at least upon said PV power measurements and said satellite images or forecasted satellite images.

5. The system of claim 1, further comprising inputs or intermediate results for forecasted irradiance and wherein said forecast model forecasts future PV power generation based at least upon said PV power measurements and said forecasted irradiance.

6. The system of claim 1, wherein said forecast model is trained based at least upon said PV power measurements by said in-situ IV measurement units.

7. A system for forecasting output power of a PV power plant, comprising:
inputs for PV power measurements by in-situ IV measurement units, and a forecast model,
wherein said forecast model forecasts future PV power generation, and
wherein said forecast model is trained based at least upon said PV power measurements by said in-situ IV measurement units.
